(19) United States
(12) Patent Application Publication
(10) Pub. No.: US 2009/0092735 A1
(43) Pub. Date: Apr. 9, 2009

(54) METHOD FOR PREPARING STABLE HOP POWDER

(75) Inventors: Naoto Yamaguchi, Bethesda, MD (US); Mitsunori Ono, Lexington, MA (US)

Correspondence Address: EDWARDS ANGELL PALMER & DODGE LLP, P.O. BOX 55874, BOSTON, MA, 02205, US

(73) Assignee: Betal, LLC, Washington, DC (US)

(21) Appl. No.: 11/868,226

(22) Filed: Oct. 5, 2007

(51) Int. Cl. C12C 3/00; C12C 3/02

(52) U.S. Cl. 426/600; 426/442; 426/456

(57) ABSTRACT

This invention features a method of making hop powder containing stable alkaline salts of hop bitter acids and an edible carrier. Also within the scope of this invention is a hop product containing alkaline salts of hop bitter acids and an edible carrier.

### BACKGROUND

Hop bitter acids have exhibited positive effect in treating diseases such as bacterial infection and diabetes. Bitter acids-containing hop products, however, only have limited therapeutic value, as bitter acids are unstable at room temperature.

It is therefore desirable to develop a new method for preparing hop products containing bitter acids in forms that confer higher stability.

### SUMMARY

This invention is based on the unexpected finding that alkaline salts of hop bitter acids (i.e., alpha, iso-alpha, and beta acids) in spray-dried powder are much more stable than their acid counterparts.

Accordingly, the present invention features a method for preparing stable hop powder containing alkaline salts of hop alpha acids, iso-alpha acids, or beta acids. This method includes three steps: (1) providing a first aqueous solution containing alkaline salts of any of the above-mentioned hop acids, (2) mixing the first aqueous solution with an edible carrier (in solid form or in an aqueous solution) to form a second aqueous solution, and (3) drying the second aqueous solution by, e.g., spray drying, to form the stable hop powder. The first and second aqueous solutions have a pH value of 6-9 when containing alkaline salts of hop alpha acids and iso-alpha acids, and have a pH value of 10-11 when containing alkaline salts of hop beta acids. The hop powder prepared by this method includes 5-80% by weight alkaline salts of hop alpha acids and/or iso-alpha acids, and 15-90% by weight an edible carrier (e.g., a water-soluble edible carrier). Alternatively, it contains 3-80% by weight alkaline salts of hop beta acids and 15-90% by weight an edible carrier. The alkaline salts can be alkali metal salts (e.g., sodium and potassium salts), or alkaline earth metal salts (e.g., calcium and magnesium salts). Examples of an edible carrier include starch, maltodextrin, cyclodextrin, methylcellulose, carbonmethoxy cellulose, xanthan gum, and aqueous solutions thereof.

The above-mentioned first aqueous solution can be prepared by placing a hop crude extract in water of a temperature above 40° C. to form a mixture, adjusting its pH with an alkali (a solid alkali or an alkaline solution) such that the hop bitter acids contained in the extract can be converted to their alkaline salts, and then collecting from the mixture an aqueous solution to obtain the first aqueous solution.

Note that hop alpha and iso-alpha acids are collectively known as humulones and humulone derivatives. Examples include but are not limited to isocohumulone, isoadnumulone, isoadhurnulone, rhoisoalpha acids (e.g., rhosiohumulone, rhoisocohumulone, and rhoadhumulone), tetrahydroisoalpha acids (e.g., tetrahydroisolhuniulone, tetrahydroisocohumulone, and tetrahydroadhumulone), and hexahydroisoalpha acids (e.g., hexahydroisohuimulone, hexahydroisocohumulone, and hexahydroadhumulone). Hop beta acids, on the other hand, are collectively known as lupulones and lupulones derivatives. Examples include lupulone, adlupulone, colupulone, tetrahydrolupulone, tetrahydroadlupulone, tetrahydrocolupulone, and their derivatives, including hexahydio beta acids and tetrahydro beta acids.

Also within the scope of this invention is a hop powder prepared by the method described above.

The present invention further provides a hop powder containing alkaline salts of hop alpha and/or iso-alpha acids (e.g., 4-10% by weight), alkaline salts of hop beta acids (e.g., 2-10% by weight), and an edible carrier. In one example, the hop powder contains 5% by weight alkaline salts of hop alpha and iso-alpha acids and 3% by weight alkaline salts of hop beta acids.

Other features or advantages of the present invention will be apparent from the following detailed description of several embodiments, and also from the appending claims.

### DETAILED DESCRIPTION

A hop powder of this invention can be prepared by mixing a first aqueous solution containing alkaline salts of hop bitter acids and an edible carrier to form a second aqueous solution, and then drying this solution to form a hop powder.

The first aqueous solution can be prepared by placing a hop extract containing bitter acids in an alkaline solution, e.g., a solution of NaOH, KOH, LiOH, Ca(OH)₂, or Mg(OH)₂, such that the first aqueous solution thus formed has a pH value (e.g., 6-11) allowing formation of alkaline salts of the bitter acids. The hop extract can be prepared by any method well known in the art, e.g., supercritical CO₂ extraction. When a hop extract contains hop oil or hop resins, it is preferred that the oil or resins be removed (e.g., by extraction with hexane or other suitable organic solvents) before it is placed in the alkaline solution.

Alternatively, the first aqueous solution can be prepared from a hop extract containing hop oil or hop resins as follows. The extract, preferably preheated to 55-70° C. (e.g., 60-65° C.), is mixed with water, which can also be preheated to the elevated temperature. A solid alkali or an alkaline solution is then added to the mixture to reach a pH under which hop bitter acids are converted to their alkaline salts. After pH adjustment, the mixture is kept at the elevated temperature for a period of time, e.g., 30 minutes to 3 hours. This process allows formation of alkaline salts of hop bitter acids and their dissolution in the aqueous phase of the mixture. Water insoluble substances, such as oil and resins, can be removed by centrifugation, filtration, or any suitable methods. The resultant supernatant or filtrate is collected to obtain the first aqueous solution.

The first aqueous solution is then mixed with an edible carrier (i.e., fit to be eaten as food) to form a second aqueous solution. The pH of this solution is adjusted, if necessary, such that the hop bitter acids remain in their alkaline salt form. The edible carrier can be starch (naturally occurring or modified), maltodextrins, cyclodextrin (naturally occurring or modified), methyl cellulose, carbonmethoxy cellulose, xanthan gum, clusterdextrin, corn syrup solids, glucose, arabic gum, calaginan, inuline, rosin, partially hydrogenated soybean oil, cellulose, hydroxymethy cellulose, hydroxyethyl cellulose, hydroxypropyl cellulose, and hypomellose. The carrier is either in solid form, or in an aqueous solution at a concentration of 20%, 30%, 50%, 75% or 90% (w/v). This aqueous solution can be subjected to pH adjustment (e.g., to 6-9 or 10-11) before mixing with the first aqueous solution.

The second aqueous solution is then dried to form a hop powder, which typically contains 5-80% (5-60%, 5-40%, or 5-20%) by weight the alkaline salts of hop bitter acids and 15-90% (35-90%, 55-90%, or 75-90%) by weight the carrier. In one example, this hop powder contains 4-10% (e.g., 5%) by weight alkaline salts of hop alpha and iso-alpha acids. In another example, it contains 2-10% (e.g., 3%) by weight alkaline salts of hop beta acids.

The hop powder thus prepared can be used as a pharmaceutical composition for treating diseases such as bacterial infection, diabetes, and inflammation. Alternatively, it can be a component of a food product (e.g., yogurt, milk, or soy milk) or a food supplement (e.g., a nutrient supply). Such a food product can be prepared by methods well known in the food industry.

Note that when different conditions (e.g., pH) are employed in the method described herein, the resultant hop powders may contain different contents of hop alpha/iso-alpha acids and hop beta acids in their alkaline salt form. These hop powders can be mixed with each other to form new hop products, which are also within the scope of this invention.

Without further elaboration, it is believed that one skilled in the art can, based on the above description, utilize the present invention to its fullest extent. The following specific examples are, therefore, to be construed as merely illustrative, and not limitative of the remainder of the disclosure in any way whatsoever.

### EXAMPLE 1

### Preparation of Hop Powder Rich in Alpha Acid Potassium Salts

An alpha acid enriched hop CO₂ extract was purchased from Haas Hop Products, Inc., Washington DC, USA (Galena Hops; lot# Y3140). 1990 g of this hop extract, containing 63.2% by weight alpha acids, 23.8% by weight beta acids, and 0.9% by weight iso-alpha acids, was mixed with 1.5 L hexane, resulting in a 3.2 L brown solution.

Half of the hexane solution (1.6 L) was first mixed with 2.0 L de-ionized water and then added with 22 ml 5M KOH to reach a pH value of 6.01. The resultant mixture was kept still for 30 minutes to allow formation of a water phase (lower layer) and a hexane phase (upper layer). The upper layer (˜1.6 L) was collected and mixed with 2.0 L de-inonized water to form a mixture. After adjusting its pH value to 8.4 with 310 ml 5M KOH, the mixture was kept still for about 30 minutes to allow separation of a water phase (lower layer) and a hexane phase (upper layer). The lower layer, an orange-colored clear solution, was collected. This solution contained 0.1% iso-alpha acids, 18% alpha acids, and 0.5% beta acids. 960 g maltodextrin (ADM CLINTOSE CR10, lot# LM00120450, Archer Daniels Midland Co, IL, USA) was dissolved in 2.6 L de-ionized water to form an aqueous solution containing 30% (w/v) maltodextrin. The pH of this solution was adjusted from 4.4 to 8.0 with 1.3 ml 5M KOH and then mixed with the organe-colored solution described above to form an aqueous solution (4 L) containing 11% (w/v) alpha acid potassium salts and 12% (w/v) maltodextrin. The pH of this aqueous solution was adjusted from 8.3 to 8.4 with 2 ml 5M KOH.

The other half of the hexane solution (1.6 L) was processed following the same procedures described above and resulted in a second 4 L aqueous solution containing 11% (w/v) alpha acid potassium salts and 12% (w/v) maltodextrin. The two 4 L aqueous solutions were mixed and then subjected to spray drying, resulting in 1.5 g yellow powder. This powder contained 39% by weight alpha acid potassium salts, 1.1% by weight beta acid potassium salts and 2.7% by weight iso-alpha acid potassium salts.

### EXAMPLE 2

### Preparation of Hop Powder Rich in Alpha Acid Sodium Salts

800 g alpha acid enriched hop CO₂ extract (Alphahop, containing 80% by weight alpha acids, 3% by weight beta acids, and 2% by weight iso-alpha acids) was pre-heated to 60-65° C. and then mixed with 3.2 L de-ionized water, which was also pre-heated to 60-65° C. The pH of the mixture thus formed was adjusted from 2.8 to 7.4 with 2M NaOH. The mixture was then kept at 60-65° C. for 30 minutes. After sitting still at room temperature overnight, the mixture was either filtered or centrifuged to remove wax, oil, and other substances that are insoluble in water. The filtrate or the aqueous phase formed after centrifugation was collected. This solution, usually brown colored, contains 0.7% (w/v) iso-alpha acid, 17% (w/v) alpha acids, and 0.2% (w/v) beta acids. The concentration of alpha acid was adjusted to 15% with water and the pH of the resultant solution was adjusted to 8.4 with NaOH. 960 g maltodextrin (ADM CLINTOSE CR10) were dissolved in water to form an aqueous solution (3.2 L) containing 30% (w/v) maltodextrin. 1.3 ml of 5M NaOH was added to the maltodextrin solution to reach a pH value of 8.4. After pH adjustment, the maltodextrin solution was mixed with the alpha-acid-containing solution to produce another aqueous solution (6.67 L), containing 9% alpha acid sodium salts and 12% maltodextrin. The pH of this solution was adjusted to 8.4 with NaOH. Filtration was applied if precipitates formed in the solution. The solution was then spray dried to yield 1.3 kg yellow fine powder. This powder contains 30-33% alpha acid sodium salts, 1-2% beta acid sodium salts, and 2-3% iso-alpha sodium salts.

### EXAMPLE 3

### Preparation of Hop Powder Rich in Beta Acid Sodium Salts

10 kg hop CO₂ extract (55% alpha acids, 30% beta acids, and 10% uncharacterized substances) was placed in Tank 1. Food grade KOH (100 g) was dissolved in 20 L de-ionized water and the solution thus formed was also added to Tank 1 to form a mixture. The mixture was stirred at 55-65° C. for one hour and then kept still to allow formation of two layers. The aqueous layer (lower layer, 15 L), containing crude beta acid potassium salts, was transferred to Tank 2 and was cooled down to room temperature. Celite was then added (0.5% wt/wt). The resulting mixture was filtered through a Buchner type filtration apparatus under vacuum. The filtrate (10 L) was collected, placed in Tank 3, and heated to 70° C. with agitation. The pH of tile filtrate was adjusted to 2-3 with 30% aqueous H₂SO₄. The filtrate was then kept still to allow formation of two layers. The upper layer (5 L), containing about 70% beta acids, was gathered. An aqueous NaOH solution (about 9 L) was added to the beta acid-containing solution and its pH was adjusted to pH 10-10.5. After the pH adjustment, the Solution was mixed with an aqueous solution containing maltodextrin (pH 10). Active charcoal (Norit A 200 mesh) was added to the resultant mixture (2% wt/wt), which was then stirred gently for thirty minutes. The mixture thus formed was stored overnight and the filtered. The filtrate was collected and diluted with de-ionized water to obtain a final aqueous solution containing about 10% (w/v) beta acid sodium salts. In an alternative approach, the above-described beta acid-containing solution was passed over a column filled with 60 mesh active charcoal. The filtrate was then spray dried to yield pale yellow powder containing 5-10% beta acid sodium salts.

### EXAMPLE 4

### Stability of Hop Acids and Alkaline Salts of Hop Acids

Hop powder containing hop acids or alkaline salts of hop acids was kept at 75° C. overnight (equivalent to storage at room temperature for one month). The content of hop acids or alkaline salts of hop acid in the hop powder was then determined at different time points by methods well known in the art. The results thus obtained are shown in Table 1 below.

TABLE 1
Contents of alpha acids, beta acids, and their alkaline salts in hop
powder stored at 75° C.

| | | IAA | | | |
|---|---|---|---|---|---|
| Sample | Time | (%) | AA (%) | IAA + AA (%) | BA (%) |
| Alpha-MD | 0 | 0.6 | 21.83 | 22.43 | 0.58 |
| | 1 | 0.6 | 22.85 | 23.45 | 0.6 |
| | 4 | 0.59 | 21.48 | 22.07 | 0.39 |
| | 24 | 0.27 | 0.45 | 0.72 | 0 |
| Ca/AA | 0 | 4.19 | 75.22 | 79.41 | 0.94 |
| | 1 | 7.3 | 76.04 | 83.34 | 0.85 |
| | 4 | 13.28 | 66.53 | 79.81 | 0.77 |
| | 24 | 38.56 | 41.56 | 80.12 | 0.68 |
| K/AA-Cap | 0 | 2.09 | 39.36 | 41.45 | 1.27 |
| | 1 | 2.53 | 40.3 | 42.83 | 1.2 |
| | 4 | 3.16 | 39.12 | 42.38 | 1.13 |
| | 24 | 6.24 | 34.19 | 40.43 | 1.01 |
| K/AA-MD | 0 | 2.13 | 38.92 | 41.15 | 1.17 |
| | 1 | 2.52 | 39.81 | 42.33 | 1.12 |
| | 4 | 3.06 | 38.62 | 41.68 | 1.05 |
| | 24 | 5.65 | 34.9 | 40.55 | 0.97 |

* Alpha-MD: hop powder containing alpha acids and malt dextrin
Ca/AA: hop powder containing alpha acid calcium salts
K/AA-Cap: hop powder containing alpha acid potassium salts and modified food starch
K/AA-MD: hop powder containing alpha acid potassium salts and malt dextrin

After 24 hours storage at 75° C., the total content of alpha and iso-alpha acids in Alpha-MD decreased from 22.43% to 0.72%. Note that alpha acids convert to iso-alpha acids during storage. Little degradation of alpha acids in their salt form was observed. For example, there is only a 0.6% decrease for the total content of alpha acid potassium salts in hop powder K/AA-MD during storage. Similarly, beta acids in their salt form are also much more stable than the acids. While no beta acids left in Alpha-MD after the 24 hours storage, the content of beta acid potassium salts only decreased from 1.17% to 0.97% in K/AA-MD during storage.

### Other Embodiments

From the above description, one skilled in die art can easily ascertain the essential characteristics of the present invention, and without departing from the spirit and scope thereof, can make various changes and modifications of the invention to adapt it to various usages and conditions. Thus, other embodiments are also within the claims.

1. A method for preparing hop powder, comprising:
providing a first aqueous solution containing alkaline salts of alpha acids and iso-alpha acids, wherein the first aqueous solution has a pH value of 6-9 and the alpha acids and iso-alpha acids are from hops,
mixing the first aqueous solution with an edible carrier to form a second aqueous solution, wherein the second aqueous solution has a pH value of 6-9, and
drying the second aqueous solution to form powder, wherein the powder contains 5-80 % by weight the alkaline salts of the alpha acids and iso-alpha acids, and 15-90% by weight the edible carrier.

2. The method of claim 1, wherein the first aqueous solution is prepared by placing a hop crude extract in water of a temperature above 40° C. to form a mixture; adjusting the pH of the mixture to 6-9 with an alkali; and collecting an aqueous phase from the mixture.

3. The method of claim 2, wherein between the adjusting and the collecting steps, the mixture is kept at 40-80° C. for 0.5-3 hours.

4. The method of claim 1, wherein the edible carrier is selected from the group consisting of starch, maltodextrin, cyclodextrin, methylcellulose, carbonmethoxy cellulose, and xanthan gum.

5. The method of claim 1, wherein the alkaline salts are sodium salts or potassium salts.

6. The method of claim 5, wherein the edible carrier is water-soluble.

7. The method of claim 6, wherein the edible carrier is modified starch or maltodextrin.

8. The method of claim 1, wherein the alkaline salts are calcium salts or magnesium salts.

9. The method of claim 1, wherein the second aqueous solution is dried by spray drying.

10. A hop powder prepared by the method of claim 1.

11. A method for preparing hop powder, comprising:
providing a first aqueous solution containing alkaline salts of beta acids, wherein the first aqueous solution has a pH value of 10-11 and the beta acids are from hops,
mixing the first aqueous solution with an edible carrier to form a second aqueous solution, wherein the second aqueous solution has a pH value of 10-11, and
drying the second aqueous solution to form powder, wherein the powder contains 3-80% by weight the alkaline salts of the beta acids and 15-90% by weight the edible carrier.

12. The method of claim 11, wherein the first aqueous solution is prepared by placing a hop crude extract in water of a temperature above 40° C.; adjusting the pH of the mixture to 10-11 with an alkali; and collecting an aqueous phase from the mixture.

13. The method of claim 2, wherein between the adjusting and collecting steps, the mixture is kept at 40 -80° C. for 0.5 -3 hours.

14. The method of claim 11, wherein the edible carrier is selected from the group consisting of starch, maltodextrin, cyclodextrin, methylcellulose, carbonmethoxy cellulose, and xanthan gum.

15. The method of claim 11, wherein the alkaline salts are sodium salts or potassium salts.

16. The method of claim 15, wherein the edible carrier is water-soluble.

17. The method of claim 16, wherein the edible carrier is modified starch or maltodextrin.

18. The method of claim 11, wherein the alkaline salts are calcium salts or magnesium salts.

19. The method of claim 11, wherein the second aqueous solution is dried by spray drying.

20. A hop powder prepared by the method of claim 11.

21. A hop powder comprising (1) alkaline salts of hop alpha acids, iso-alpha acids and beta acids; and (2) an edible carrier.

22. The hop powder of claim 21, wherein the powder contains 4-10 % by weight the alkaline salts of the hop alpha acids and iso-alpha acids.

23. The hop powder of claim 22, wherein the powder contains 2-10 % by weight the alkaline salts of the hop beta acids.

24. The hop powder of claim 21, wherein the alkaline salts are sodium salts, potassium salts, calcium salts, or magnesium salts.

25. The hop powder of claim 21, wherein the edible carrier is selected from the group consisting of starch, maltodextrin, cyclodextrin, methylcellulose, carbonmethoxy cellulose, and xanthan gum.

26. The hop powder of claim 21, wherein the hop powder contains 5-40% by weight alkaline salts of hop alpha acids, iso-alpha acids, and beta acids.
